(19) United States
(12) Patent Application Publication
(10) Pub. No.: US 2017/0329429 A1
(43) Pub. Date: Nov. 16, 2017

(54) INPUT DEVICE

(71) Applicants: PIONEER CORPORATON, Tokyo (JP); TOHOKU PIONEER CORPORATION, Yamagata (JP)

(72) Inventors: Kohei TOYODA, Yamagata (JP); Satoshi SUZUKI, Yamagata (JP); Akiko NAKAGAMI, Yamagata (JP); Ryotaro HAMADA, Yamagata (JP); Masakazu TAKAHASHI, Yamagata (JP)

(21) Appl. No.: 15/527,582

(22) PCT Filed: Nov. 20, 2014
(86) PCT No.: PCT/JP2014/080798

§ 371 Date: May 17, 2017

(51) Int. Cl. G06F 3/041; G06F 3/0354

(52) U.S. Cl. CPC G06F 3/041; G06F 3/03547

(57) ABSTRACT

In the input device, the contact surface is provided in the housing, and is exposed to the outside of the housing at the part of the opening. A user makes an input operation by making the contact body in contact with the contact surface. When the contact surface detects the movement of the contact body in a predetermined direction by detecting the contact position of the contact body, the drive unit moves the contact surface to perform the direction detection operation. When the direction detection operation is performed, the user can recognize that the input operation the user made was accepted.

### TECHNICAL FIELD

The present invention relates to a multi-directional input device.

### BACKGROUND TECHNIQUE

As an example of a multi-directional input switch, Patent Reference-1 discloses a four-directional switch. It may be considered that such a four-directional switch is provided on a door or a steering wheel of an automobile. For example, this switch can be used as a mirror switch to remotely control angles of left and right mirrors provided on an automobile body from a driver's seat. In addition, this switch can be used to turn on or off various electronic devices in a compartment of the automobile, such as a car air conditioner, a car audio, vehicle interior lighting and a TV for rear seats.

### PRIOR ART REFERENCE

### Patent Reference

Patent Reference-1: Japanese Patent Application Laid-open under No. H10-106397

### DISCLOSURE OF INVENTION

### Problem to be Solved by the invention

In the four-directional switch of Patent Reference-1, the position of the switch is determined in advance. Therefore, when a user selects a desired switch from those four switches, visual assistance is required. However, as a switch possibly operated during an automobile driving, a switch requiring the visual assistance is not preferable.

The above is one example of a problem to be solved by the present invention. It is an object of the present invention to provide an input device that can be operated with selecting a desired switch by tactile sense, without requiring visual assistance.

### Means for Solving the Problem

One invention described in claims is an input device comprising: a contact surface configured to detect a contact position of a contact body; a housing including an opening which exposes the contact surface; and a drive unit configured to move the contact surface relative to the housing, wherein, when the contact surface detects movement of the contact body in a predetermined N (N is a natural number) direction, the drive unit performs a direction detection operation which moves the contact surface relative to the housing in a same direction as the predetermined direction or in an opposite direction to the predetermined direction.

### BRIEF DESCRIPTION OF THE DRAWINGS

FIG. 1 is a perspective view illustrating an appearance of an input device according to an embodiment.

FIG. 2 illustrates a manner that a user makes an input operation to the input device.

FIGS. 3A to 3D illustrate examples of the input operations to the input device.

FIGS. 4A to 4C illustrate examples of the input operations to the input device.

FIG. 5 illustrates an example of the input operation to the input device.

FIGS. 6A and 6B are diagrams illustrating directions in which the input operation can be made.

FIG. 7 is a block diagram illustrating a functional configuration of the input device.

FIGS. 8A to 8C illustrate direction detection operations.

FIG. 9 is a flowchart of a same direction moving operation.

FIG. 10 is a flowchart of an opposite direction moving operation.

FIG. 11 is a flowchart of a mixed moving operation.

FIGS. 12A and 12B are timing charts of the direction detection operations.

FIG. 13 is a perspective view schematically illustrating a configuration of a drive unit.

FIGS. 14A and 14B are perspective views illustrating a detailed configuration of the drive unit.

FIGS. 15A and 15B are perspective views illustrating a detailed configuration of a drive mechanism.

FIG. 16 illustrates an example in which the input device is applied to a steering wheel of an automobile.

### FORMS TO EXERCISE THE INVENTION

According to one aspect of the present invention, there is provided an input device comprising: a contact surface configured to detect a contact position of a contact body; a housing including an opening which exposes the contact surface; and a drive unit configured to move the contact surface relative to the housing, wherein, when the contact surface detects movement of the contact body in a predetermined N (N is a natural number) direction, the drive unit performs a direction detection operation which moves the contact surface relative to the housing in a same direction as the predetermined direction or in an opposite direction to the predetermined direction.

In the above input device, the contact surface is provided in the housing, and is exposed to the outside of the housing at the part of the opening. A user makes an input operation by making the contact body in contact with the contact surface. When the contact surface detects the movement of the contact body in a predetermined direction by detecting the contact position of the contact body, the drive unit moves the contact surface and performs the direction detection operation relative to the housing. When the direction detection operation is performed, the user can recognize that the input operation the user made was accepted. In a preferred example, the N is four or one.

In one mode of the above input device, the direction detection operation includes a same direction moving operation which moves the contact surface a predetermined distance in a substantially same direction as the moving direction of the contact body. In this mode, by the same direction moving operation, the user can recognize that the input operation was accepted.

In another mode of the above input device, the direction detection operation includes an opposite direction moving operation which moves the contact surface a predetermined distance in a substantially opposite direction to the moving direction of the contact body. In this mode, by the opposite direction moving operation, the user can recognize that the input operation was accepted.

In still another mode of the above input device, the direction detection operation performs a same direction moving operation which moves the contact surface a predetermined distance in a substantially same direction as the moving direction of the contact body, and then performs an opposite direction moving operation which moves the contact surface a predetermined distance in a substantially opposite direction to the moving direction of the contact body. In this mode, by the same direction moving operation and the opposite direction moving operation, the user can recognize that the input operation was accepted.

In a preferred example in this case, a moving distance that the contact surface moves by the same direction moving operation is equal to a moving distance that the contact surface moves by the opposite direction moving operation. Therefore, the position of the contact surface before the same direction moving operation becomes equal to the position of the contact surface after the opposite direction moving operation.

Namely, in still another mode of the above input device, the contact surface comprises a neutral position, the same direction moving operation starts from the neutral position, and the opposite direction moving operation ends at the neutral position. Thus, the contact surface can be basically kept at the neutral position.

In still another mode of the above input device, the contact surface is provided with a switch, and switching of the switch is performed by pressing down the contact surface after movement of the contact body is detected. In this mode, the input operation is made by two steps, i.e., the moving operation of the contact body and the pressing-down operation of the contact surface. In this case, preferably the switching is notified to the contact body by vibrating the contact surface in a predetermined direction in parallel with the contact surface. More preferably, during the switching, the vibration continues to notify that the switching is valid.

### Embodiments

Now, a preferred embodiment of the present invention will be described with reference to the attached drawings.

### DEVICE CONFIGURATION

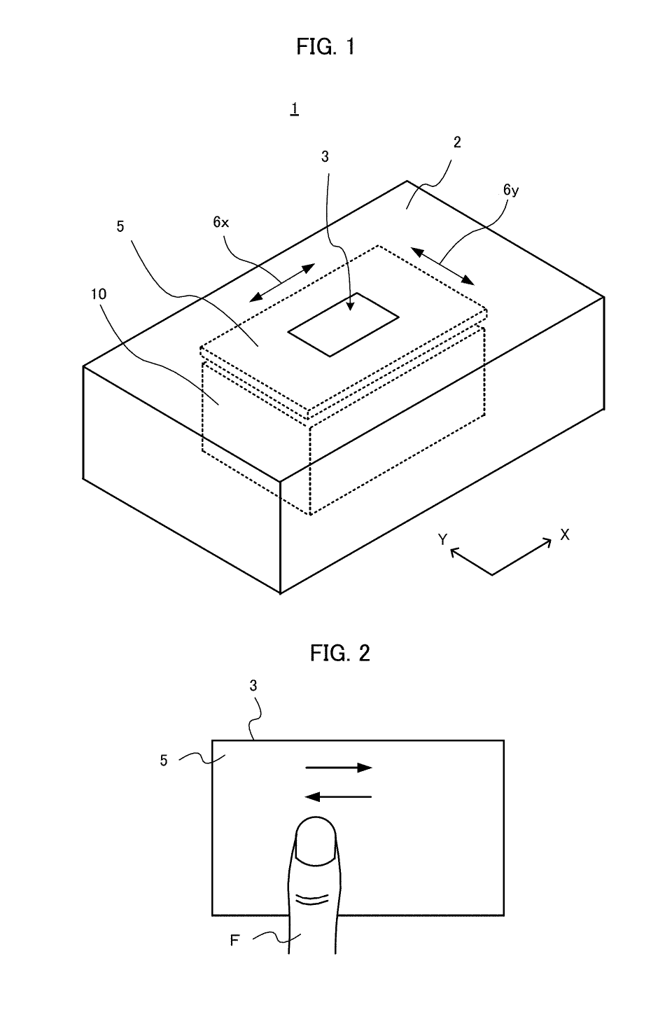

FIG. 1 illustrates an appearance of an input device according to the embodiment. The input device 1 includes a housing 2, a contact surface 5 and a drive unit 10. The housing 2 is formed with an opening 3 at its upper surface, and the contact surface 5 and the drive unit 10 are provided inside the housing 2. The contact surface 5 is an input element such as a touch pad, and a user makes a contact body in contact with the contact surface 5 to make an input. A typical example of the contact body is a finger of the user.

The contact surface 5 is arranged directly under the upper surface of the housing 2 at the position to cover the opening 3 from its lower side. Namely, when the input device 1 is viewed from the upper side, the contact surface 5 is exposed in the opening 3 formed on the upper surface of the housing 2. As shown by the arrows 6x and 6y, the contact surface 5 is moved in the X-direction and the Y-direction in FIG. 1 by the drive unit 10. It is noted that the X-direction corresponds to the left-right direction of the opening 3 and the Y-direction corresponds to the up-down direction of the opening 3. In the following description, “up-down direction” indicates the Y-direction, and “left-right direction” indicates the X-direction. The detail of the drive unit 10 will be described later.

### INPUT OPERATION

FIG. 2 illustrates a manner that the user makes an input operation to the input device 1. Since the contact surface 5 is exposed only inside the opening 3 as described above, the user makes a contact with the contact surface 5 inside the opening 3 to make an input.

FIG. 2 illustrates the manner that the user makes an input by using a finger F as the contact body. The user can select one of a plurality of options by performing an operation of moving the finger F with keeping it in contact with the contact surface 5 (generally called “drag”).

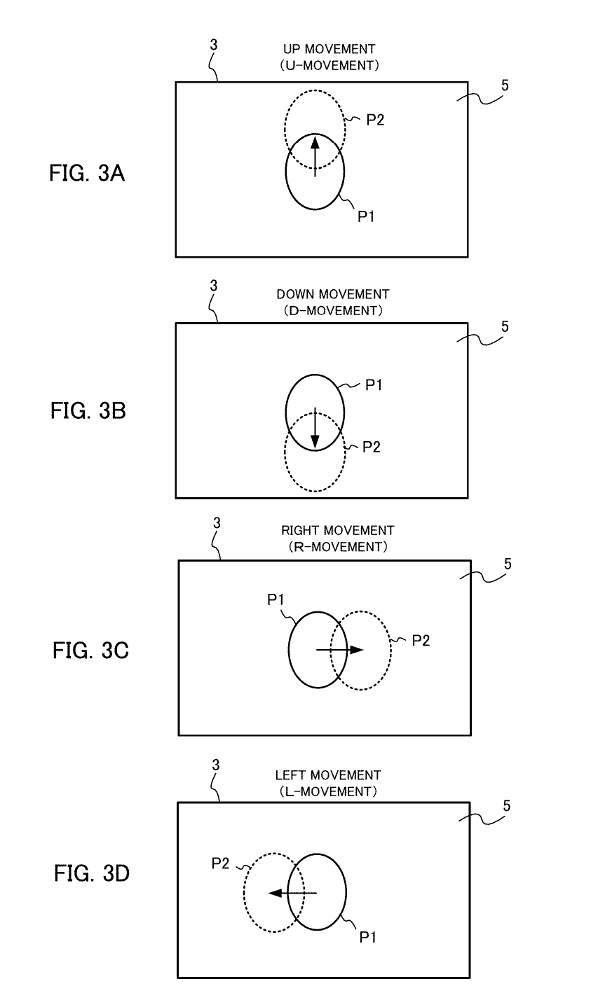

The input device 1 of this embodiment enables the input in four directions, i.e., up, down, left and right directions. FIGS. 3A to 3D show the input operations in four directions. In FIGS. 3A to 3D, the solid ellipse P1 indicates the position of the finger F before the movement by the input operation (specifically, the area in which the finger F contacts the contact surface 5), and the broken line ellipse P2 indicates the position of the finger F after the movement.

FIG. 3A shows up movement (hereinafter referred to as “U-movement”). The up movement is the input operation in which the finger F is moved upward. FIG. 3B shows down movement (hereinafter referred to as “D-movement”). The down movement is the input operation in which the finger F is moved downward. FIG. 3C shows right movement (hereinafter referred to as “R-movement”). The right movement is the input operation in which the finger F is moved rightward. FIG. 3D shows left movement (hereinafter referred to as “L-movement”). The left movement is the input operation in which the finger F is moved leftward.

These input operations are determined by a control unit 7 described later based on a movement locus (coordinates) of the position of the finger F outputted by the contact surface 5. Namely, if the movement locus of the finger F is upward, the input operation is determined to be the up movement.

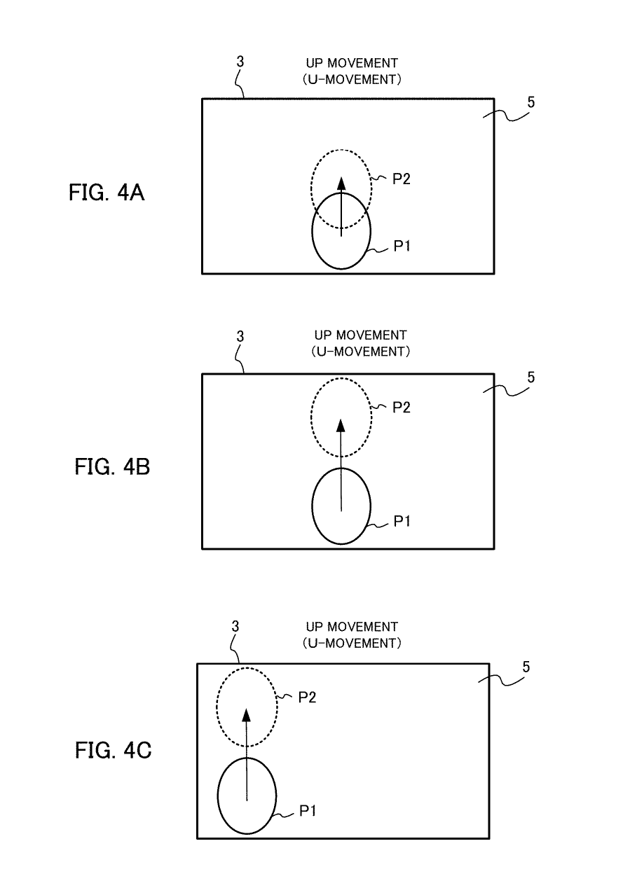

While FIGS. 3A to 3D show the input operations in which the finger F is moved upward, downward, leftward or rightward approximately from the center of the opening 3, the start position of the movement of the finger F is not limited to the center of the opening 3. FIGS. 4A to 4D show other examples. As shown in FIG. 4A, the input operation of moving the finger F from the bottom to the center of the opening 3 is also determined as the up movement. Also, as shown in FIG. 4B, when the moving direction is upward, it is determined as the up movement even if the moving distance is long. Further, as shown in FIG. 4C, when the moving direction is upward, it is determined as the up movement even if the start position of the movement is near the edge of the opening 3.

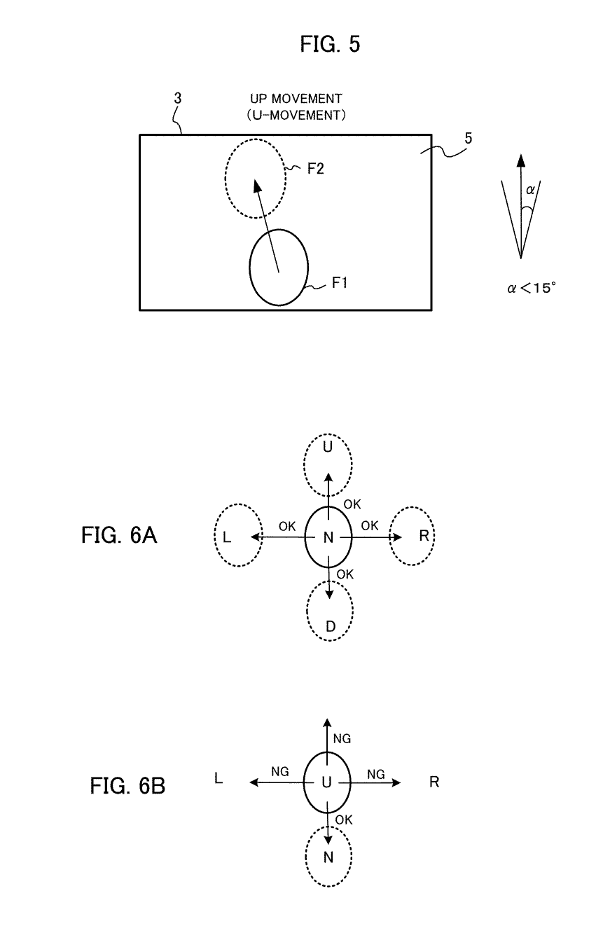

Next, determination criteria for the input operation will be described. Since the input device 1 according to the embodiment is four-directional input device, the moving direction of the finger F is determined as one of the four directions, i.e., up, down, left or right, even if the moving direction of the finger F is slightly oblique. For example, if the moving direction of the finger F is determined to be one of the four directions if the moving direction of the finger F is within 15° with respect to the four directions. FIG. 5 shows an example of the up movement. As shown in FIG. 5, even if the moving direction of the finger F is not correctly in the upward direction, if the deviation of the moving direction is within 15°, the input operation is determined to be the up movement. On the contrary, if the moving direction of the finger F is obliquely deviated from the four directions more than 15°, the input operation is determined to be invalid.

Additionally, in order to be determined as the movement in one of the four directions, the moving distance of the finger F needs to be longer than a predetermined distance. Namely, the input operation shorter than the predetermined distance is determined to be invalid.

As described above, in this embodiment, the operation of moving the finger F the distance longer than the predetermined distance in the direction within 15° from the four directions is determined as the input operation. These processing can be achieved by existing software technique generally used for smartphones.

Next, description will be given of the direction in which the input operation can be made. The direction in which the input operation can be made is determined by an imaginary current position. The imaginary current position is the current position that the control unit 7 recognizes, and is not necessarily coincident with the actual position of the contact surface 5 relative to the housing 2.

As shown in FIG. 6A, when the imaginary current position is at a neutral position N, the input operation can be made in the four directions, i.e., up, down, left and right directions. However, when the imaginary current position is at an upper position U, the input operation in the up, left and right direction from there cannot be made, and only the input operation in the down direction can be made. After the imaginary current position moves downward to return to the neutral position N, the input operation in the four directions can be made.

The reason why the movement in the up, left and right direction cannot be made when the imaginary current position is at the upper position U is not to make the input operation too complicated for the user. If the visual information like FIG. 6A can be obtained by a head-up display or else, the movement in the up, left and right direction can be made possible even if the imaginary current position is at the upper position U.

### FUNCTIONAL CONFIGURATION

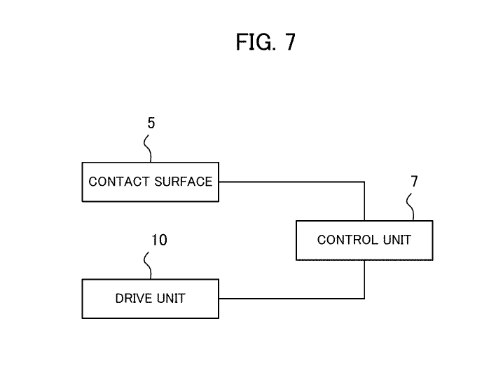

FIG. 7 is a block diagram illustrating a functional configuration of the input device 1. As illustrated, the contact surface 5 and the drive unit 10 are controlled by the control unit 7. The contact surface 5 constituted by a touch pad or the like detects the contact by the finger F, and outputs coordinates corresponding to the movement of the finger F to the control unit 7. The control unit 7 detects the input operation based on the coordinates indicating the movement of the finger F. Specifically, the control unit 7 detects the moving direction and the moving distance of the finger F based on the coordinates indicating the movement of the finger F, and determines the movement in one of the four directions (up, down, left or right) when the moving direction is within 15° from the four directions and the moving distance is longer than the predetermined distance.

Further, the control unit 7 controls the drive unit 10 to move the contact surface 5 in the up, down, left and right directions. Specifically, when the input operation is made by the user, the control unit 7 performs a direction detecting operation that moves the contact surface 5 by the drive unit 10.

### DIRECTION DETECTION OPERATION

When the input operation is made by the user, the direction detection operation is performed to notify the user that the input operation was accepted. Therefore, the direction detection operation is performed when the finger F of the user is moved more than the predetermined distance in the direction within 15° of one of the four directions and the movement is determined to be one of the upward, downward, rightward or leftward direction. Specifically, the direction detection operation is performed by the drive unit 10 which moves the contact surface 5. When the direction detection operation is performed, the user can recognize that the input operation was accepted. This enables a tactile input without the need of user's visual observation. Hereinafter, three examples of the direction detection operation will be described.

(Same Direction Moving Operation)

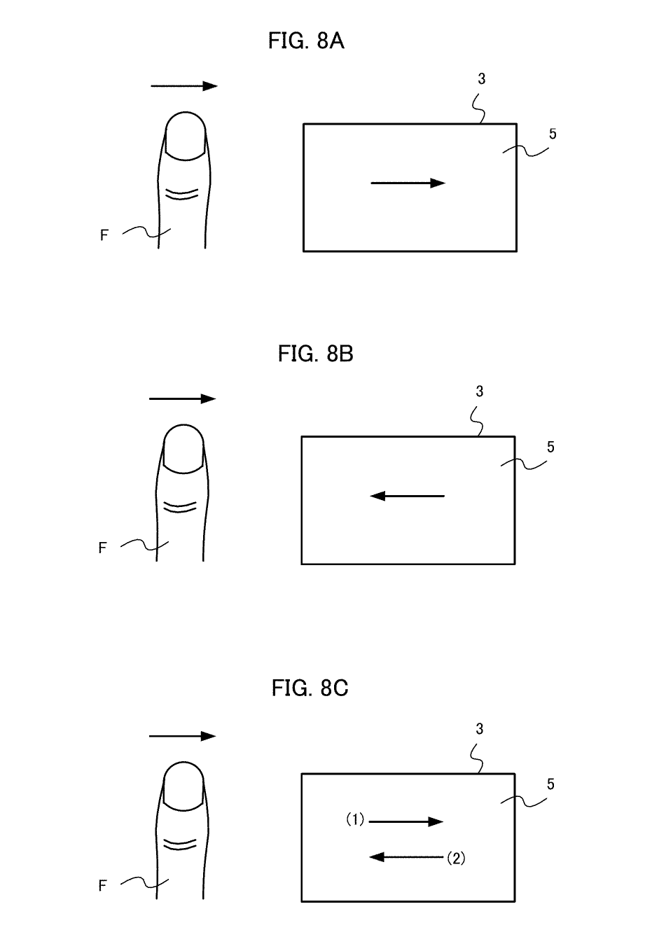

The same direction moving operation is to move the contact surface 5 in the same direction as the moving direction of the finger F when the input operation by the movement of the finger F is detected. FIG. 8A shows an example of the same direction moving operation. In this example, the input operation in the right direction is made by the finger F, and the contact surface 5 is moved in the right direction.

In this example, by performing the same direction moving operation, the user can recognize that the input operation in the right direction was accepted. Namely, when the user makes the input operation by moving the finger F in the right direction, the contact surface 5 also moves in the right direction. The user senses the movement of the contact surface 5 by the finger F, and recognizes that the input operation in the right direction was accepted. The same direction moving operation has such an advantage that the user can clearly recognize the direction of the accepted input operation.

(Opposite Direction Moving Operation)

The opposite direction moving operation is to move the contact surface 5 in the direction opposite to the moving direction of the finger F when the input operation by the movement of the finger F is detected. FIG. 8B shows an example of the opposite direction moving operation. In this example, the input operation in the right direction is made by the finger F, and the contact surface 5 is moved in the opposite, left direction.

In the opposite direction moving operation, since the finger F of the user slides on the contact surface 5 by the movement of the contact surface 5 in the opposite direction, it is possible to give the user such a feeling that the finger F of the user is moving in the direction of the input operation. The opposite direction moving operation is particularly advantageous when the contact surface 5 is small.

(Mixed Moving Operation)

The mixed moving operation is a mixed operation of the same direction moving operation and the opposite direction moving operation. Specifically, when the input operation by the movement of the finger F is detected, the contact surface 5 is first moved in the same direction as the detected moving direction of the finger F, and then is moved in the opposite direction to the detected moving direction of the finger F. In this case, it is preferred that the moving distance to the same direction as the moving direction of the finger F is equal to the moving distance in the opposite direction. FIG. 8C shows an example of the mixed moving operation. In this example, the input operation in the right direction is made by the finger F. The contact surface 5 is first moved in the right direction and then is moved in the opposite, left direction.

It seems that the user can get most natural feeling in the mixed moving operation if the user gets used to it. Also, since the contact surface 5 stays at the neutral position most of time, there is such an advantage that both the hardware and software can be easily controlled.

### SWITCHING CONFIRMING OPERATION

In the above examples, when the direction detection operation is performed, the input operation by the user has been accepted. Namely, the control unit 7 recognizes the input operation by the user as the instruction of selecting one of the plural options corresponding to the four directions and determining the selection. This input method will be called “one-step input method”.

Instead, the input operation by the user may be performed by two-steps, i.e., selection of the options and determination of the selection. This input method will be called “two-step input method”. Also, the input for selecting the option will be called “selection input”, and the input for determining the selection will be called “determination input”. In the two-step input method, the control unit 7 first recognizes the movement in the up, down, left or right direction by the user as the selection input, and performs the direction detection operation indicating that the selection input is accepted.

In the two-step input method, since the selection is not determined yet even after the direction detection operation, the user needs to further perform switching operation as the determination input. For example, the user's operation of pressing the finger F down on the contact surface 5 may be the switching operation. When the control unit 7 detects the switching operation by the user, it vibrates the contact surface 5 as the switching confirming operation. Thus, the user can recognize that the switching operation was accepted, i.e., the input by the two-step input method was completed. Accordingly, tactile inputs without visual observation by the user can be performed.

As the switching operation, a long pressing operation of the contact surface 5 may be used instead of the pressing-down operation of the contact surface 5. Also, both the pressing-down operation and the long pressing operation may be used as the switching operation.

It is noted that which one of the one-step input method and the two-step input method should be used can be determined in accordance with applications used with the input device.

### PROCESSING FLOW

Next, processing flows of the above direction detection operation will be described.

(Same Direction Moving Operation)

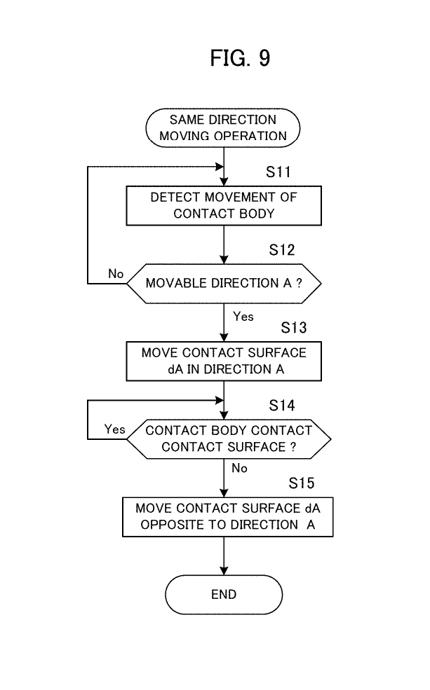

FIG. 9 is a flowchart of the same direction moving operation.

This processing is executed by the control unit 7. FIG. 9 shows an example in a case where the above-mentioned one-step input method is employed, i.e., the switching operation and the switching confirming operation are not performed.

First, the control unit 7 detects the movement of the contact body (the finger F) based on the detection signal from the contact surface 5 (step S11), and determines whether or not the moving direction is the movable direction A (step S12). When the moving direction is not the movable direction A (step S12: No), the processing returns to step S11.

When the moving direction is the movable direction A (step S12: Yes), the control unit 7 controls the drive unit 10 to move the contact surface 5 a predetermined distance dA in the direction A (step S13). By this movement, the user can recognize that the input operation by the one-step input method was accepted.

Next, the control unit 7 determines whether or not the contact body is in contact with the contact surface 5 based on the detection signal from the contact surface 5 (step S14). When the contact body is in contact with the contact surface 5 (step S14: Yes), step S14 is continued.

On the other hand, when the contact body is not in contact with the contact surface 5 (step S14: No), i.e., the contact body is released from the contact surface 5, the control unit 7 controls the drive unit 10 to move the contact surface 5 the distance dA in the direction opposite to the direction A (step S15). By this, the contact surface 5 returns to the position before the movement. Then, the processing ends.

As described above, in the same direction moving operation, the contact surface 5 moves the predetermined distance in the same direction as the moving direction of the contact body, and then returns to its original position. Therefore, if the input operation is started when the imaginary position is at the neutral position, the imaginary position after the same direction moving operation returns to the neutral position.

(Opposite Direction Moving Operation)

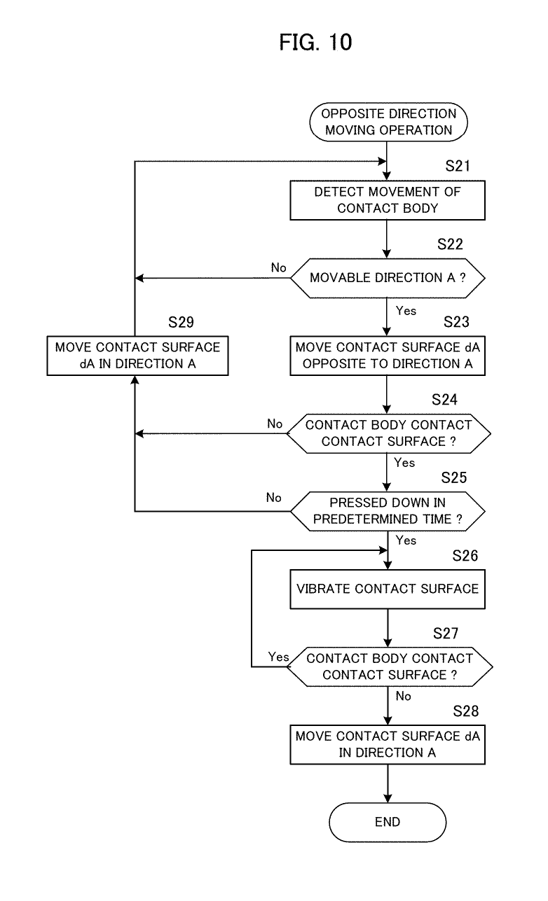

FIG. 10 is a flowchart of the opposite direction moving operation. This processing is executed by the control unit 7. FIG. 10 shows an example in a case where the above-mentioned two-step input method is employed, i.e., the switching operation and the switching confirming operation are performed.

First, the control unit 7 detects the movement of the contact body (the finger F) based on the detection signal from the contact surface 5 (step S21), and determines whether or not the moving direction is the movable direction A (step S22). When the moving direction is not the movable direction A (step S22: No), the processing returns to step S21.

When the moving direction is the movable direction A (step S22: Yes), the control unit 7 controls the drive unit 10 to move the contact surface 5 a predetermined distance dA in the direction opposite to the direction A (step S23). By this movement, the user can recognize that the selection input of the two-step input method was accepted.

Next, the control unit 7 determines whether or not the contact body is in contact with the contact surface 5 based on the detection signal from the contact surface 5 (step S24). When the contact surface 5 is not in contact with the contact surface 5, i.e., the contact body is released from the contact surface 5 (step S24: No), the processing goes to step S29.

On the other hand, when the contact body is in contact with the contact surface 5 (step S24: Yes), the control unit 7 determines whether or not the pressing-down of the contact surface 5 is made within a predetermined time period after the contact surface 5 is moved in step S23 (step S25). This pressing-down corresponds to the switching operation as the above-mentioned determination input. When the pressing-down is not made within the predetermined time period (step S25: No), the processing goes to step S29.

If the processing goes to step S29, it corresponds to the case where the selection input was made but the determination input was not made. Therefore, in step S29, the control unit 7 controls the drive unit 10 to move the contact surface 5 the distance dA in the direction A. Thus, the contact surface 5 returns to the position before the movement.

On the other hand, when the pressing-down is made within the predetermined time period (step S25: Yes), the control unit 7 controls the drive unit 10 to vibrate the contact surface 5 (step S26). This vibration corresponds to the above-mentioned switching confirming operation. By this vibration, the user can recognize that the determination input of the two-step input method was accepted.

Next, the control unit 7 determines whether or not the contact body is in contact with the contact surface 5 (step S27). When the contact body is in contact with the contact surface 5 (step S27: Yes), step S26 is continued. On the other hand, when the contact body is not in contact with the contact surface 5, i.e., the contact body is released from the contact surface 5 (step S27: No), the control unit 7 controls the drive unit 10 to move the contact surface the distance dA in the direction A (step S28). Thus, the contact surface 5 returns to the position before the movement. Then, the processing ends.

As described above, in the opposite direction moving operation, the contact surface 5 is moved the predetermined distance in the direction opposite to the movement direction of the contact body, and then returns to its original position. Therefore, if the input operation is started when the imaginary position is at the neutral position, the imaginary position after the opposite direction moving operation returns to the neutral position.

(Mixed Moving Operation)

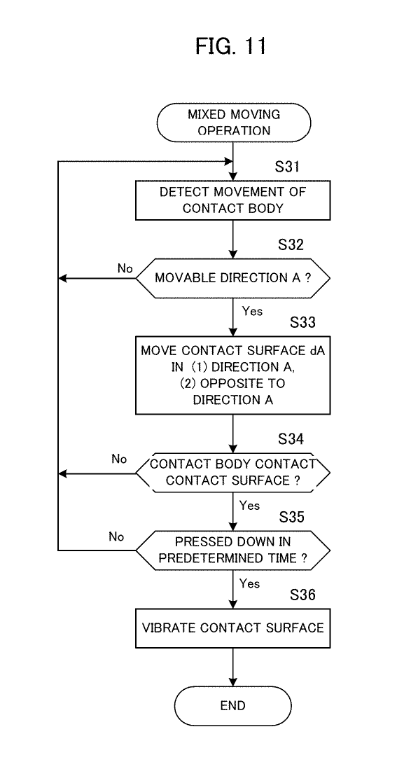

FIG. 11 is a flowchart of the mixed moving operation. This processing is executed by the control unit 7. FIG. 11 shows an example in a case where the above-mentioned two-step input method is employed, i.e., the switching operation and the switching confirming operation are performed.

First, the control unit 7 detects the movement of the contact body (the finger F) based on the detection signal from the contact surface 5 (step S31), and determines whether or not the moving direction is the movable direction A (step S32). When the moving direction is not the movable direction A (step S32: No), the processing returns to step S31.

When the moving direction is the movable direction A (step S32: Yes), the control unit 7 controls the drive unit 10 to first move the contact surface 5 a predetermined distance dA in the direction A and then move the contact surface 5 the predetermined distance dA in the direction opposite to the direction A (step S33). Thus, the contact surface 5 returns to its original position. By this movement, the user can recognize that the selection input of the two-step input method was accepted.

Next, the control unit 7 determines whether or not the contact body is in contact with the contact surface 5 based on the detection signal from the contact surface 5 (step S34). When the contact surface 5 is not in contact with the contact surface 5, i.e., the contact body is released from the contact surface (step S34: No), the processing returns to step S31. This corresponds to the case where the selection input was made but the determination input was not made.

On the other hand, when the contact body is in contact with the contact surface 5 (step S34: Yes), the control unit 7 determines whether or not the pressing-down of the contact surface 5 is made within a predetermined time period after the contact surface 5 is moved in step S33 (step S35). This pressing-down corresponds to the switching operation as the above-mentioned determination input. When the pressing-down is not made within the predetermined time period (step S35: No), the processing returns to step S31. This also corresponds to the case where the selection input was made but the determination input was not made.

On the other hand, when the pressing-down is made within the predetermined time period (step S35: Yes), the control unit 7 controls the drive unit 10 to vibrate the contact surface 5 (step S36). This vibration corresponds to the above-mentioned switching confirming operation. By this vibration, the user can recognize that the determination input of the two-step input method was accepted. Then, the processing ends.

As described above, in the mixed moving operation, the contact surface 5 is first moved the predetermined distance in the same direction as the moving direction of the contact body, and then moved the predetermined distance in the opposite direction to return to its original position. Therefore, if the input operation is started when the imaginary position is at the neutral position, the imaginary position after the mixed moving operation returns to the neutral position.

### EXAMPLES OF DIRECTION DETECTION OPERATIONS

Next, examples of the direction detection operations will be described.

(Same Direction Moving Operation)

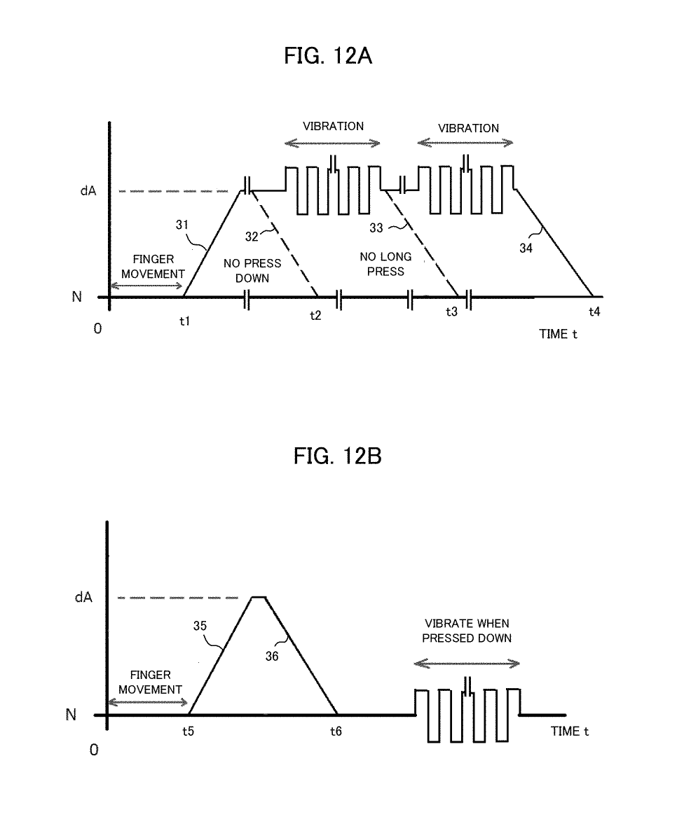

FIG. 12A shows an example of a timing chart of the same direction moving operation. In FIG. 12A, the horizontal axis indicates time and the vertical axis indicates the moving distance from the neutral position (N) of the contact surface 5. In the example of FIG. 12A, the above-mentioned two-step input method is employed, and the pressing-down and the long pressing are used as the switching operation.

When the user moves the finger F on the contact surface 5 between the time 0 to t1, the control unit 7 moves the contact surface 5 the predetermined distance dA from the neutral position in the same direction as the moving direction of the finger F as shown by the solid line 31. Then, when the predetermined time has passed without the pressing-down by the user, the control unit 7 moves the contact surface 5 the predetermined distance dA in the direction opposite to the moving direction of the finger F as shown by the broken line 32. Thus, the contact surface 5 returns to the neutral position at the time t2.

If the user pressed down the contact surface 5, the control unit 7 vibrates the contact surface 5 as the switching confirming operation. Then, when the predetermined time has passed without the long pressing by the user, the control unit 7 moves the contact surface 5 the predetermined distance dA in the direction opposite to the moving direction of the finger F as shown by the broken line 33. Thus, the contact surface 5 returns to the neutral position at the time t3.

On the other hand, if the user makes the long-pressing of the contact surface 5, the control unit 7 vibrates the contact surface 5 as the switching confirming operation, and further moves the contact surface 5 the predetermined distance dA in the direction opposite to the moving direction of the finger F as shown by the broken line 34. Thus, the contact surface 5 returns to the neutral position at the time t4.

(Opposite Direction Moving Operation)

The timing chart of the opposite direction moving operation is the same as the timing chart of the same direction moving operation shown in FIG. 12A except for that the moving direction of the contact surface 5 is opposite, i.e., in the negative direction of the graph.

(Mixed Moving Operation)

FIG. 12B shows an example of a timing chart of the mixed moving operation. In FIG. 12B, the horizontal axis indicates time and the vertical axis indicates the moving distance from the neutral position (N) of the contact surface 5. In the example of FIG. 12B, the above-mentioned two-step input method is employed, and the pressing-down is used as the switching operation.

When the user moves the finger F on the contact surface 5 between the time 0 to t5, the control unit 7 moves the contact surface 5 the predetermined distance dA from the neutral position in the same direction as the moving direction of the finger F as shown by the solid line 35, and then moves the contact surface 5 the predetermined distance dA in the opposite direction as shown by the solid line 36. Thus, the contact surface 5 returns to the neutral position at the time t6. Thereafter, if the user presses down the contact surface 5, the control unit 7 vibrates the contact surface 5 as the switching confirming operation.

### DRIVE UNIT

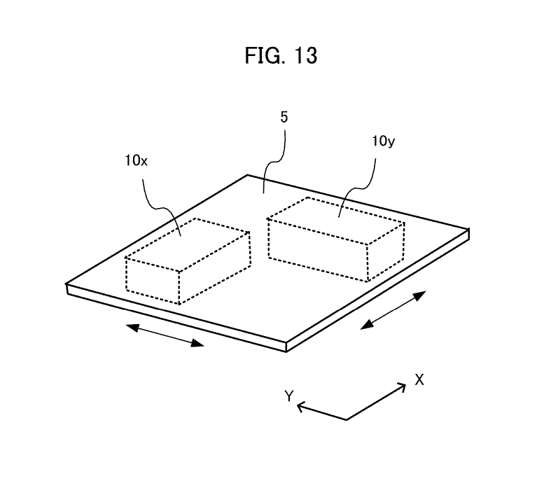

Next, the drive unit 10 will be described in detail. FIG. 13 schematically shows the positional relation between the contact surface 5 and the drive unit 10. In FIG. 13, the drive unit 10 includes the drive units 10x and 10y. The drive unit 10x moves the contact surface 5 in the X-direction, and the drive unit 10y moves the contact surface 5 in the Y-direction. Thus, the contact surface 5 can be moved in the X/Y directions, i.e., the four directions of the up, down, left and right directions.

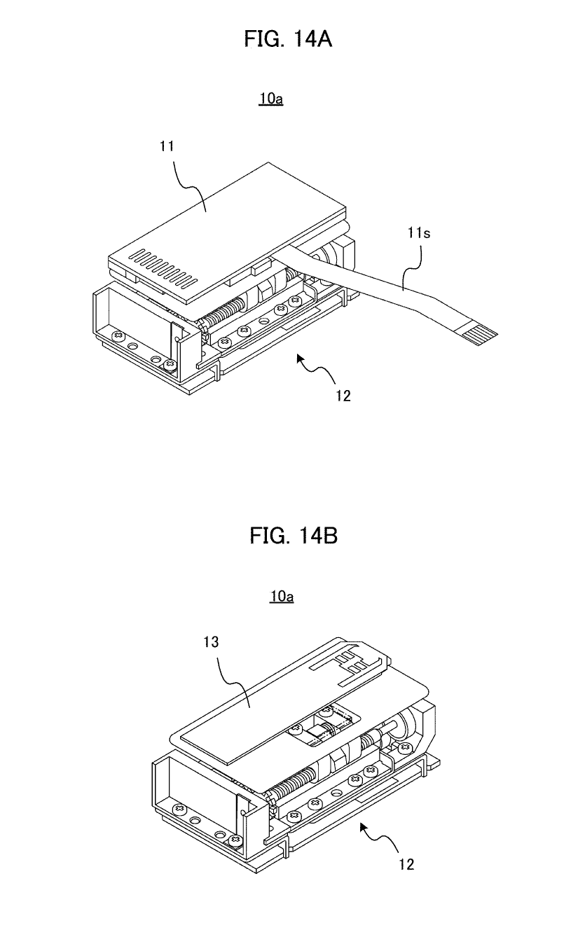

FIG. 14A shows an example of detailed configuration of the drive unit. For the brevity of the explanation, the drive unit 10a shown in FIG. 14A moves the contact surface 5 in a single axis direction. The drive unit 10a includes a touch pad 11 serving as the contact surface 5 and a drive mechanism 12 for moving the touch pad 11. The touch pad 11 constitutes the contact surface 5, which may be of an electrostatic capacitance type, a resistance film type or other types. The touch pad 11 detects the movement (the position, the speed, the moving distance, etc.) when the user moves the finger F, and outputs the detection signal to the control unit 7 via the signal line 11s.

FIG. 14B shows the state when the touch pad 11 is removed from the drive unit 10a shown in FIG. 14A. A pressure sensor 13 is provided under the touch pad 11. The pressure sensor 13 detects the pressure that the contact surface 5 receives from the finger F, and outputs the detection signal to the control unit 7. The pressure sensor 13 is of an analog type, and its threshold can be set by the control unit 7. Therefore, in addition to the simple ON/OFF operation, the pressure sensor 13 can detects the level of the force with which the user is pressing the contact surface 5 by setting plural stepwise thresholds.

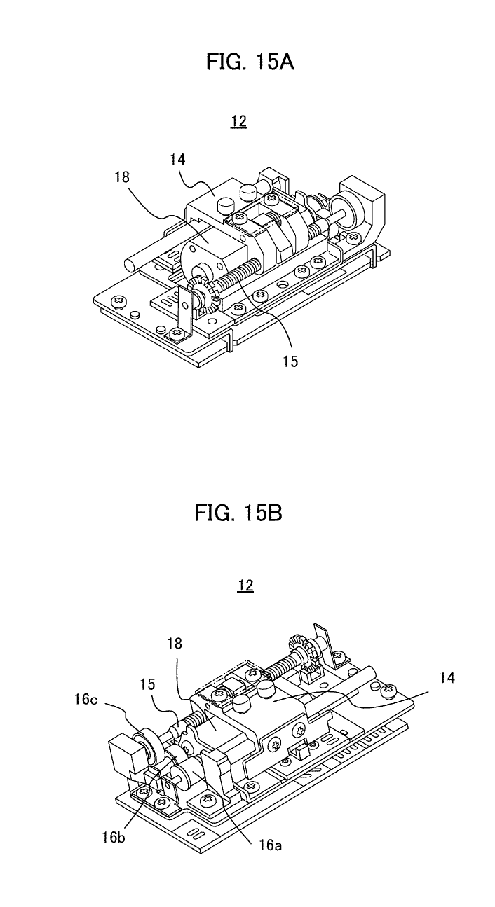

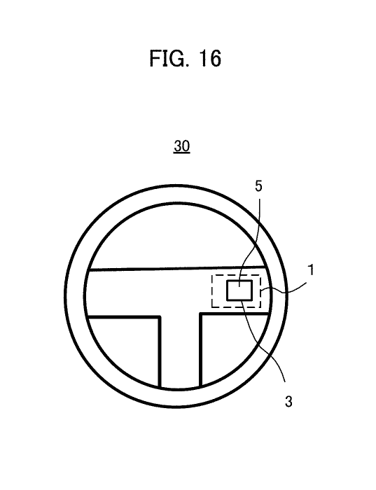

FIG. 15A shows a perspective view of the drive mechanism 12, in which the pressure sensor and some cover members are removed from FIG. 14B. FIG. 15B shows a perspective view of the drive mechanism 12 from the opposite side of FIG. 15A.

The drive mechanism 12 is to slide the touch pad 11 in the horizontal direction. Specifically, the rotation of the motor 18 is transferred to the shaft 15 via the gears 16a to 16c. The shaft 15 is formed with a feed screw. When the shaft rotates, the slider 14 engaged with the feed screw moves in the coaxial direction of the shaft 15. Since the slider 14 is fixed to the surface member including the touch pad 11 and the pressure sensor 13 shown in FIGS. 14A and 14B, the rotation of the motor 18 can slide the touch pad 11. Also, the friction caused by this slide operation creates the tactile sensation with vector component.

Further, by switching the moving direction of the touch pad 11 in an extremely short time, the contact surface 5 can be vibrated.

### APPLICATION EXAMPLE

FIG. 16 shows an example in which the input device 1 of the embodiment is applied to a steering wheel of an automobile. The input device 1 is embedded near the right end of the steering wheel 30, and the contact surface 5 is exposed in the opening 3. By making inputs to the contact surface 5 by the thumb during driving, the driver can operate various devices in the interior of the automobile.

### MODIFIED EXAMPLES

The above embodiment shows the input device 1 which receives the input of the four directions, i.e., the up, down, left and right directions. However, the application of the invention is not limited to this. One drive unit shown in FIGS. 14A, 14B, 15A and 15B may be provided to form an input device capable of receiving the input in a single axis direction (one direction or two directions). Alternatively, three or more drive units may be provided to enable the input of other directions.

In the above embodiment, the input operation by the finger F of the user basically starts from the neutral position and ends at the neutral position. However, the application of the invention is not limited to this. The start position and the end position of the input operation may be anywhere on the contact surface 5 as long as the movement can be detected. Also, the start position and the end position of the input operation may be different.

### INDUSTRIAL APPLICABILITY

This invention can be used for an input device which enables multi-directional input operation.

### DESCRIPTION OF REFERENCE NUMERALS

1 Input Device

2 Housing

3 Opening

5 Contact Surface

7 Control Unit

10 Drive Unit

12 Drive Mechanism

1. An input device comprising:
a contact surface configured to detect a contact position of a contact body;
a housing including an opening which exposes the contact surface; and
a drive unit configured to move the contact surface relative to the housing,
wherein, when the contact surface detects movement of the contact body in a predetermined N (N is a natural number) direction, the drive unit performs a direction detection operation which moves the contact surface relative to the housing in a same direction as the predetermined direction or in an opposite direction to the predetermined direction.

2. The input device according to claim 1, wherein the direction detection operation includes a same direction moving operation which moves the contact surface a predetermined distance in a substantially same direction as the moving direction of the contact body.

3. The input device according to claim 1, wherein the direction detection operation includes an opposite direction moving operation which moves the contact surface a predetermined distance in a substantially opposite direction to the moving direction of the contact body.

4. The input device according to claim 1, wherein the direction detection operation performs a same direction moving operation which moves the contact surface a predetermined distance in a substantially same direction as the moving direction of the contact body, and then performs an opposite direction moving operation which moves the contact surface a predetermined distance in a substantially opposite direction to the moving direction of the contact body.

5. The input device according to claim 4, wherein a moving distance that the contact surface moves by the same direction moving operation is equal to a moving distance that the contact surface moves by the opposite direction moving operation.

6. The input device according to claim 5,
wherein the contact surface comprises a neutral position, and
wherein the same direction moving operation starts from the neutral position, and the opposite direction moving operation ends at the neutral position. 15

7. The input device according to claim 1, wherein the N is four.

8. The input device according to claim 1, wherein the N is one.

9. The input device according to claim 1,
wherein the contact surface is provided with a switch, and
wherein switching of the switch is performed by pressing down the contact surface after movement of the contact body is detected.

10. The input device according to claim 9, wherein the switching is notified to the contact body by vibrating the contact surface in a predetermined direction in parallel with the contact surface.

11. The input device according to claim 10, wherein, during the switching, the vibration continues to notify that the switching is continuing.
